(19) United States
(12) Patent Application Publication
(10) Pub. No.: US 2009/0131006 A1
(43) Pub. Date: May 21, 2009

(54) APPARATUS, INTEGRATED CIRCUIT, AND METHOD OF COMPENSATING IQ PHASE MISMATCH

(75) Inventor: Chia-Hsin Wu, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/942,743

(22) Filed: Nov. 20, 2007

(51) Int. Cl. H04B 1/16

(52) U.S. Cl. 455/257

(57) ABSTRACT

An apparatus, an integrated circuit, and a method of compensating I/Q (inphase/quadrature) phase mismatch. The apparatus comprises a mixer, a phase detector, and a calibration controller. The mixer mixes an inphase calibration signal with an inphase component of a local oscillation signal to generate a first signal, mixes a quadrature calibration signal with a quadrature component of the local oscillation signal to generate a second signal, and mixes an incoming RF signal with the local oscillation signal to demodulate the incoming RF signal. The phase detector coupled to the mixer, determines a phase difference between the first and second signals. The calibration controller coupled to the phase detector, adjusts phases of the inphase and quadrature calibration signals such that the phase difference is substantially 90 degrees.

### BACKGROUND OF THE INVENTION

1. Field of the Invention

The invention relates in general to inphase (I) and quadrature (Q) phase calibration, and in particular, to an integrated circuit and a method of compensating IQ phase mismatch.

2. Description of the Related Art

In modern wireless communication systems, data are transmitted by inphase (I) and quadrature phase (Q) signal components. The receiving data are demodulated by a local oscillation signal in a typical receiver. Ideally, the local oscillation signal has inphase and quadrature components that have a phase difference (I/Q phase) of 90 degrees and form a gain ratio (I/Q gain) of unity. However, imperfections in analog circuitry cause imbalance of the I/Q gain (I/Q gain is not of unity) and I/Q phase (I/Q phase is not 90 degrees out-of-phase), degrading transmitted data quality including bit error rate (BER). Thus, a need exists for an IC and a method to compensate I/Q phase mismatch in the local oscillation signal of a receiver.

### BRIEF SUMMARY OF THE INVENTION

A detailed description is given in the following embodiments with reference to the accompanying drawings.

According to an embodiment of the invention, a method of compensating I/Q (inphase/quadrature) phase mismatch in a receiver is disclosed, the receiver comprises a mixer capable of mixing an incoming RF (Radio Frequency) signal with a local oscillation signal, the method comprising the mixer mixing an inphase calibration signal with an inphase component of the local oscillation signal to generate a first signal, the mixer mixing a quadrature calibration signal with a quadrature component of the local oscillation signal to generate a second signal, determining a phase difference between the first and second signals, and adjusting phases of the inphase and quadrature calibration signals such that the phase difference is substantially 90 degrees.

According to another embodiment of the invention, an integrated circuit capable of compensating I/Q (inphase/quadrature) phase mismatch is provided, comprising a mixer, a phase detector, and a calibration controller. The mixer mixes an inphase calibration signal with an inphase component of a local oscillation signal to generate a first signal, mixes a quadrature calibration signal with a quadrature component of the local oscillation signal to generate a second signal, and mixes an incoming RF signal with the local oscillation signal to demodulate the incoming RF signal. The phase detector coupled to the mixer, determines a phase difference between the first and second signals. The calibration controller coupled to the phase detector, adjusts phases of the inphase and quadrature calibration signals such that the phase difference is substantially 90 degrees.

According to yet another embodiment of the invention, an apparatus capable of compensating I/Q phase mismatch of a local oscillation signal is provided. The apparatus comprises a mixer, a phase detector, and a calibration controller. The mixer mixes an inphase calibration signal with an inphase component of a local oscillation signal to generate a first signal, mixes a quadrature calibration signal with a quadrature component of the local oscillation signal to generate a second signal, and mixes an incoming RF signal with the local oscillation signal to demodulate the incoming RF signal. The phase detector coupled to the mixer, determines a phase difference between the first and second signals. The calibration controller coupled to the phase detector, adjusts phases of the inphase and quadrature calibration signals such that the phase difference is substantially 90 degrees.

### BRIEF DESCRIPTION OF THE DRAWINGS

The invention can be more fully understood by reading the subsequent detailed description and examples with references made to the accompanying drawings, wherein:

FIG. 1 is a block diagram of a conventional heterodyne receiver.

FIG. 2 is a block diagram of an exemplary heterodyne receiver according to the invention.

FIG. 3 is a block diagram of the heterodyne receiver in FIG. 2 in the phase calibration stage.

FIG. 4 is a block diagram of the heterodyne receiver in FIG. 2 in the normal operation stage.

FIG. 5 is a circuit schematic of the mixer in FIG. 2.

FIG. 6 is a circuit schematic of the phase detector in FIG. 2.

FIG. 7 is a block diagram of an exemplary direct conversion receiver according to the invention.

FIG. 8 is a block diagram of an exemplary weaver image reject receiver according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

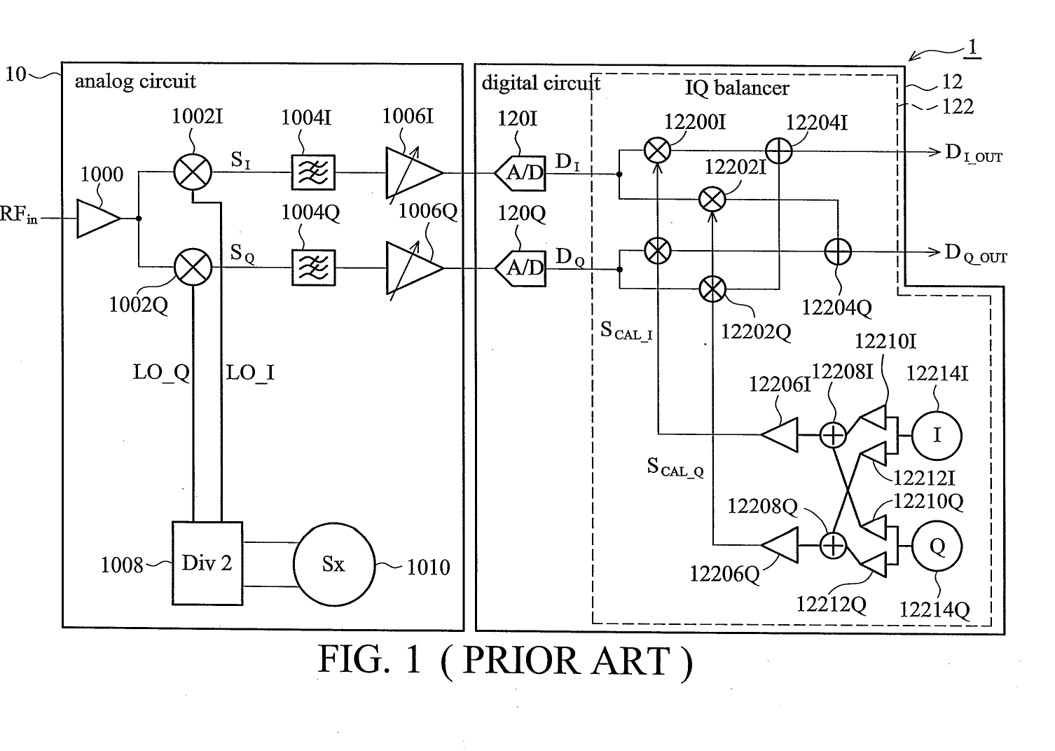

FIG. 1 is a block diagram of a conventional heterodyne receiver, comprising analog circuit 10 and digital circuit 12 coupled thereto.

Analog circuit 10 comprises low noise amplifier (LNA) 1000, mixers 1002I, Q, filters 1004I, Q, amplifiers 1004I, Q, divider 1008, and local oscillator 1010. LNA 1000 is coupled to mixers 1002I, Q, filter 1004I, Q, and subsequently to amplifier 1006I, Q. Local oscillator 1010 is coupled to divider 1008, and subsequently to mixers 1002I, Q.

An antenna (not shown) receives incoming RF signal RFᵢₙ from the air and filters it in a band select filter (not shown) to remove out-of-band signals thereof. LNA1000 then amplifies the filtered RF signal RFᵢₙ without introducing additional noise, before down-converting the filtered RF signal Fᵢₙ to the intermediate frequency (IF) by Mixers 1002I, Q. Mixers 1002I, Q mix the amplified RF signal RFᵢₙ with local oscillation signals LO_I and LO_Q to produce inphase and quadrature IF signals S_{I} and S_{Q} with intermediate frequency, which in turn is filtered by filters 1004I, Q and amplified by programmable gain amplifiers (PGA) 1006I, Q. Local oscillation signals LO_I and LO_Q are derived by local oscillator 1010 and are approximately 90 degrees out-of-phase with each other.

Due to the imperfection of analog circuit 10, local oscillation signals LO_I and LO_Q from local oscillator 1010 are not exactly 90 degrees out-of-phase with each other, requiring correction for the phase and gain imbalance.

Digital circuit 12 comprises analog-to-digital converters (ADC) and IQ balancer 122 coupled thereto. ADC 120I, Q converts amplified input signals S_{I} and S_{Q} to digital signals D_{I} and D_{Q}. IQ balancer 122 comprises mixers 12200I, Q and 12202I, Q, adders 12204I, Q, fixed gain amplifiers 12206I, Q, adders 12208I, Q, variable gain amplifiers 12210I, Q and 12212I, Q, and frequency synthesizers 12214I, Q. IQ balancer 122 compensates I/Q gain and I/Q phase mismatch of local oscillation signals LO_I and LO_Q by mixing signals D_{I} and D_{Q} with inphase and quadrature calibration signals S_{CAL}_{_{—}}_{I} and S_{CAL}_{_{—}}_{Q}, generating compensated inphase and quadrature output signals D_{I}_{_{—}}_{OUT} and D_{Q}_{_{—}}_{OUT}. Calibration signals S_{CAL}_{_{—}}_{I} and S_{CAL}_{_{—}}_{Q} are derived by frequency synthesizers 12214I, Q, with phase θ adjusted through variable gain amplifiers 12210I, Q and gain G through fixed gain amplifiers 12206I, Q. Frequency synthesizers 12214I, Q may be digital frequency synthesizers generating digital signal at a low frequency range, for example, 100 kHz.

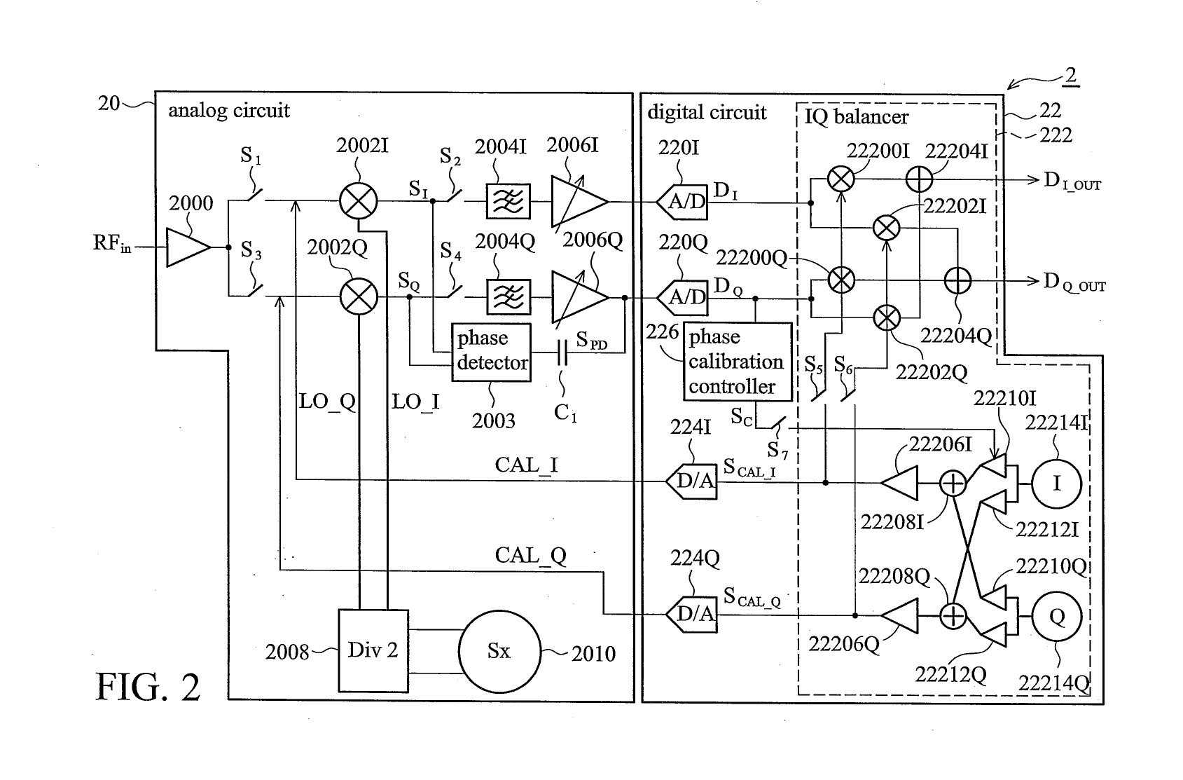

FIG. 2 is a block diagram of an exemplary heterodyne receiver according to the invention, comprising analog circuit 20 and digital circuit 22 coupled thereto.

Analog circuit 20 comprises LNA 2000, mixers 2002I, Q, phase detector 2003, capacitor C1, filters 2004I, Q, amplifiers 2004I, Q, divider 2008, local oscillator 2010, and switches S1 through S4. LNA 2000 is coupled to mixers 2002I, Q, filter 2004I, Q, and subsequently to amplifier 2006I, Q. Local oscillator 2010 is coupled to divider 2008, and subsequently to mixers 2002I, Q. Mixers 2002I, Q are coupled to phase detector 2003, to capacitor C1, and next to filter 2004Q.

Incoming RF signal RFᵢₙ received by an antenna (not shown) is filtered in a band select filter (not shown) to remove the out-of-band signals. LNA2000 amplifies the filtered RF signal RFᵢₙ. Mixers 2002I, Q down convert amplified RF signal RFᵢₙ by local oscillation signals LO_I and LO_Q to produce inphase and quadrature IF signals S_{I} and S_{Q}, which are filtered by filters 2004I, Q and amplified by programmable gain amplifiers (PGA) 2006I, Q. Mixers 2002I, Q can also mix local oscillation signals LO_I and LO_Q with calibration signals CAL_I and CAL_Q to generate first and second signals S_{I} and S_{Q} respectively. Phase detector 2003 receives first signal S_{I} and second signal S_{Q} to determine phase difference S_{PD} therebetween. After removing a DC component by DC block capacitor C₁ and filtering out unwanted frequency components by low pass filter 2004Q, phase difference S_{PD} is transmitted to digital circuit 22 for IQ phase compensation. During calibration mode, switches S1 through S4 are opened so that phase detector 2003 can detect phase difference S_{PD} between inphase and quadrature LO signals LO_I and LO_Q. During normal operation, switches S1 through S4 are closed to demodulate incoming RF signal RFᵢₙ by LO signals LO_I and LO_Q.

Calibration signals CAL_I and CAL_Q have an identical reference frequency f_{ref}. Phase detector 2003 may be a squaring circuit squaring a sum of first and second signals S_{I} and S_{Q} to generate phase difference signal S_{PD}, with a frequency two-times greater than reference frequency f_{ref}. The magnitude of phase difference signal S_{PD} indicates the I/Q phase mismatch of LO signals LO_I and LO_Q. When inphase and quadrature signals LO_I and LO_Q are substantially orthogonal to each other, phase difference signal S_{PD} approaches to 0. The IQ phase mismatch is estimated by adjusting phase θ of calibration signals S_{CAL}_{_{—}}_{I} and S_{CAL}_{_{—}}_{Q} so that the magnitude of phase difference signal S_{PD} is minimized, rendering 90 degrees phase difference of first and second signals S_{I} and S_{Q}. When phase difference signal S_{PD} is minimized, first and second signals S_{I} and S_{Q} are orthogonal, the adjusted phase θ is stored in phase calibration controller 226 as the IQ phase mismatch to be used for phase compensation.

Local oscillation signals LO_I and LO_Q are derived from local oscillator 2010 through divider 2008 and approximately 90 degrees out-of-phase with each other. Incoming RF signal RFᵢₙ comprises inphase and quadrature components and may be a single ended signal or a differential signal pair. Local oscillation signals LO_I and LO_Q may also be single ended signals or differential signal pairs corresponding to incoming RF signal RFᵢₙ. Filters 2004I, Q may be channel filters performing channel selection at an intermediate frequency. Amplifiers 2006I,Q are a programmable gain amplifiers (PGA) with variable amplifier gain amplifying the filtered IF signals S_{I} and S_{Q}.

Digital circuit 22 comprises ADC 2201, Q, digital-to-analog converters (DAC) 2241,Q, and IQ balancer 222 coupled therebetween, and phase calibration controller 226 coupled between ADC 220Q and IQ balancer 222. ADC 2201, Q convert amplified input signals S_{I} and S_{Q} to digital signals D_{I} and D_{Q} in normal operation, and phase difference signal S_{PD} to digital signal S_{PD} in calibration mode. DAC 224I,Q converts digital calibration signals S_{CAL}_{_{—}}I and S_{CAL}_{_{—}}_{Q} to analog calibration signals CAL_I and CAL_Q. Phase calibration controller 226 stores digital phase difference signal S_{PD} and adjusts phase θ of inphase and quadrature calibration signals S_{CAL}_{_{—}}I and S_{CAL}_{_{—}}_{Q} so that the phase difference signal S_{PD} is substantially 90 degrees. Phase calibration controller 226 adjusts phase θ by controlling IQ balancer to generate calibration signals S_{CAL}_{_{—}}I and S_{CAL}_{_{—}}_{Q}.

IQ balancer 222 comprises mixers 22200I, Q and 22202I, Q, adders 22204I, Q, fixed gain amplifiers 22206I, Q, adders 22208I, Q, variable gain amplifiers 22210I, Q and 22222I, Q, frequency synthesizers 22214I, Q, and switches S5 through S7. IQ balancer 222 compensates I/Q gain and I/Q phase mismatch of local oscillation signals LO_I and LO_Q by mixing signals D_{I} and D_{Q} with inphase and quadrature calibration signals S_{CAL}_{_{—}}I and S_{CAL}_{_{—}}_{Q}, producing compensated inphase and quadrature output signals D_{I}_{_{—}}_{OUT} and D_{Q}_{_{—}}_{OUT}. Frequency synthesizers 22214I, Q generates calibration signals S_{CAL}_{_{—}}_{I} and S_{CAL}_{_{—}}_{Q}, with reference frequency f_{ref}, phase θ adjusted through variable gain amplifiers 22210I, Q and 22212I, Q, and gain G adjusted through fixed gain amplifiers 22206I, Q.

During calibration mode, switches S5 through S6 are opened and S7 is closed to determine phase difference signal S_{PD} for I/Q phase mismatch of the LO signals LO_I and LO_Q. During normal operation, switches S5 through S6 are closed to compensate inphase and quadrature IF signals D_{I} and D_{Q} by adjusting phase θ with difference signal S_{PD} to produce output inphase and quadrature signals.

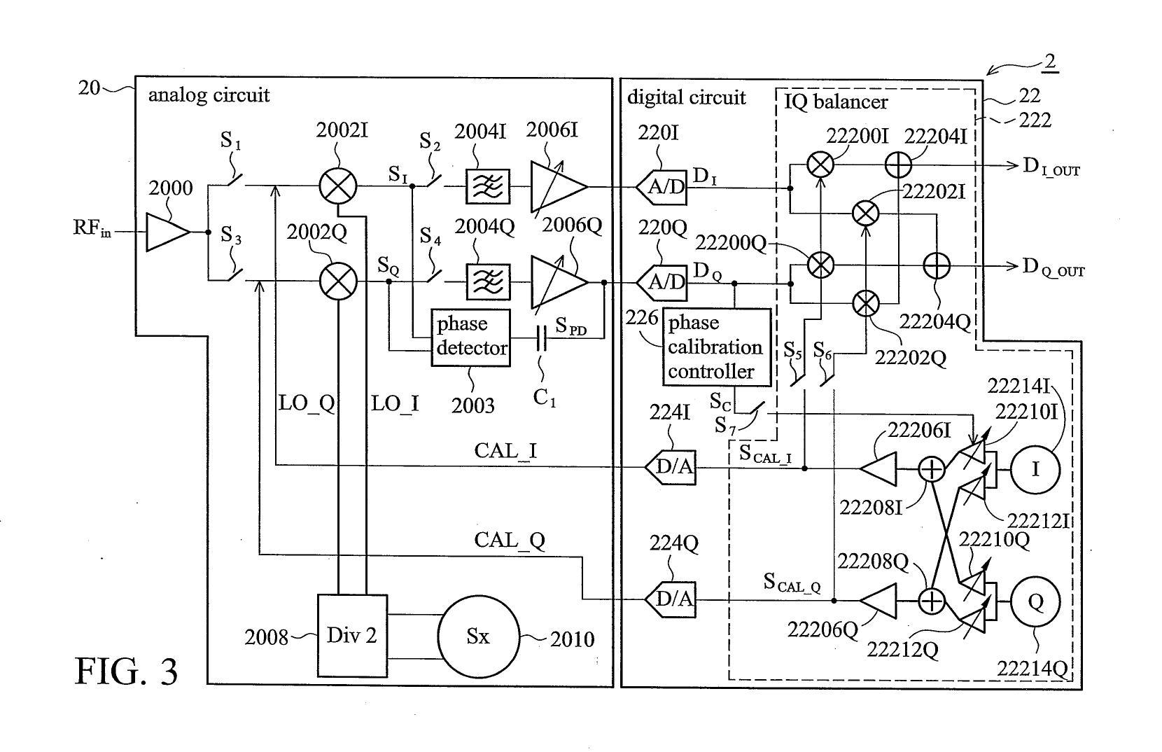

FIG. 3 is a block diagram of the heterodyne receiver in FIG. 2 in the phase calibration stage.

When switches S1 through S6 are opened, mixers 2002I, Q mix LO signals LO_I and LO_Q with calibration signals CAL_I and CAL_Q to establish first signal S_{I} and second signal S_{Q}, to next pass through phase detector 2003 to detect phase difference S_{PD} therebetween, afterwhich the DC component is removed by DC block capacitor C₁ and unwanted frequency components are removed by filter 2004Q, whereafter the phase difference S_{PD} is converted to a digital signal stored in phase calibration controller 226. Phase calibration controller 226 then determines I/Q phase mismatch between LO signals LO_I and LO_Q according to phase difference S_{PD}, and stores the I/Q phase mismatch.

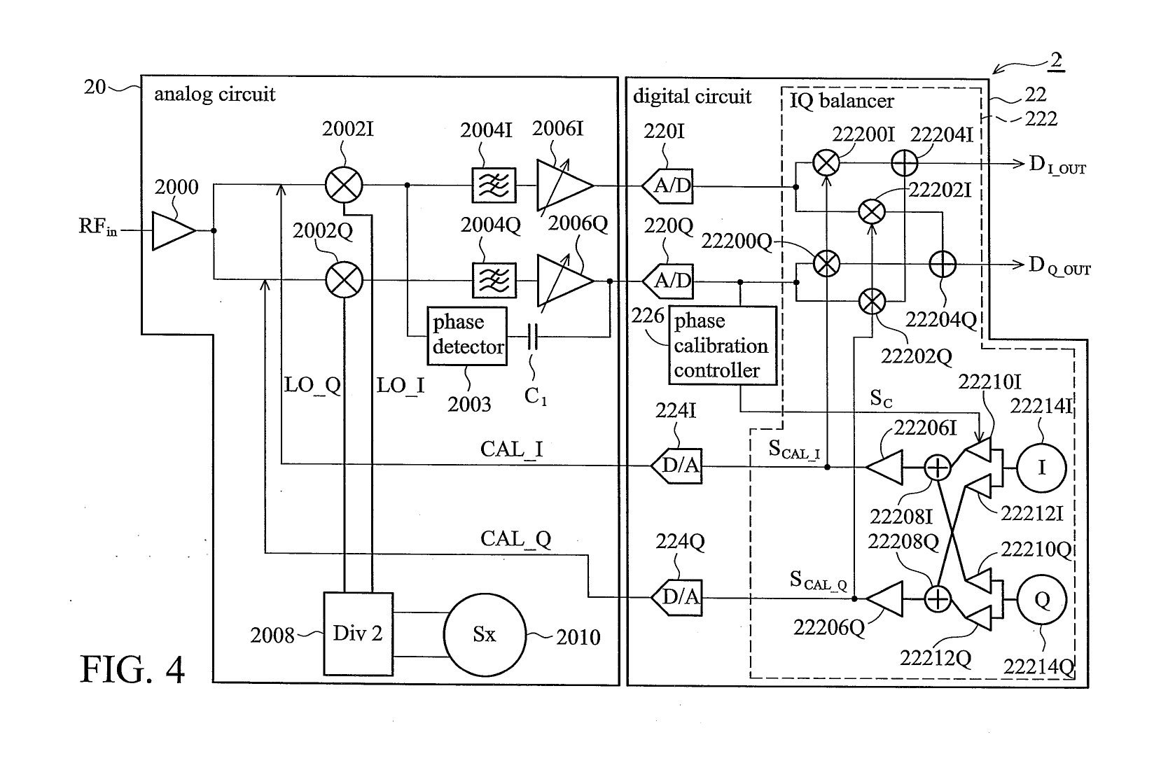

FIG. 4 is a block diagram of the heterodyne receiver in FIG. 2 in the normal operation stage.

When switches S1 through S6 are closed, incoming RF signal RFᵢₙ is demodulated by the LO signal to produce IF signals S_{I} and S_{Q} to digital circuit 22, afterwhich is converted to digital, signals S_{I} and S_{Q} are compensated by adjusting phase θ by the I/Q phase mismatch corresponding to phase difference S_{PD} to generate compensated output signals D_{I}_{_{—}}_{OUT} and D_{Q}_{_{—}}_{OUT}.

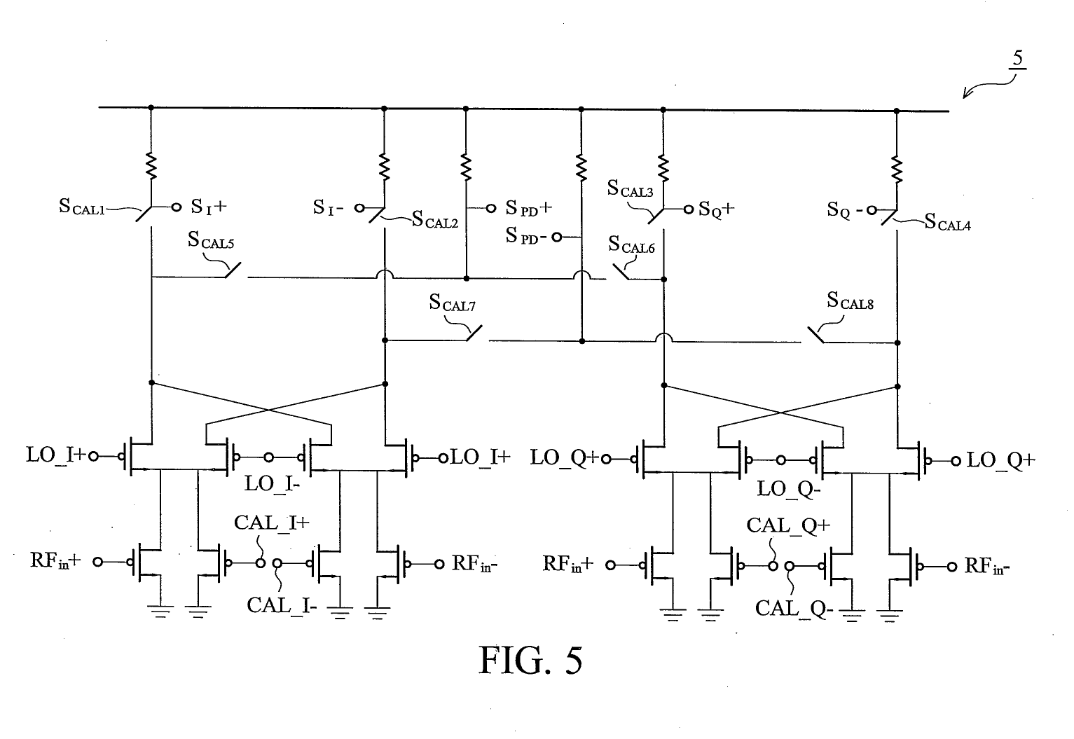

FIG. 5 is a circuit schematic of the mixer in FIG. 2. Mixer 5 comprises 2 pairs of modified Gilbert cells. During calibration, switches S_{CAL1} through S_{CAL4} are opened and switches S_{CAL5} through S_{CAL8} are closed to generate the first and second signals for phase difference detection in phase detector 2003. During normal operation, switches S_{CAL1} through S_{CAL4} are closed and switches S_{CAL5} through S_{CAL8} are opened to generate inphase signal S_{I} across terminals S₁+ and S₁− and quadrature signal S_{Q} across terminals S_{Q}+ and S_{Q}−.

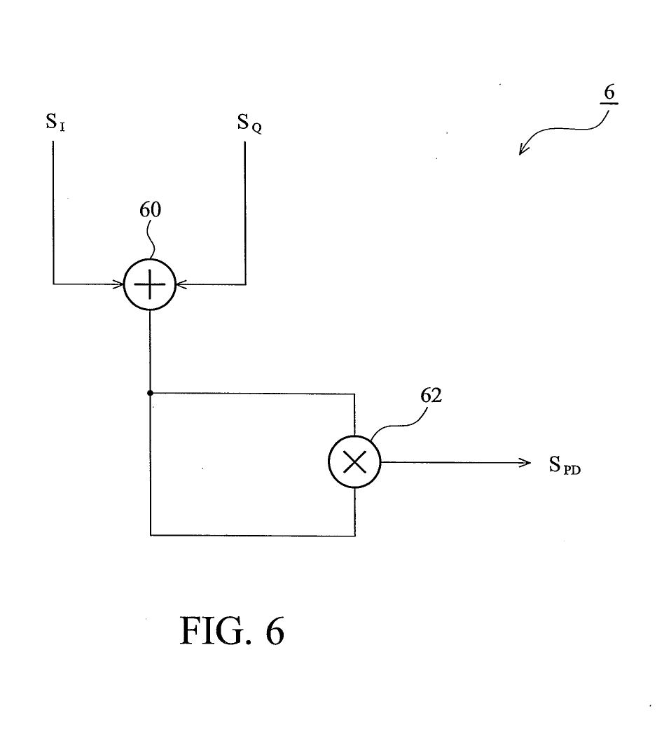

FIG. 6 is a circuit schematic of the phase detector in FIG. 2, comprising adder 60 and multiplier 62 coupled thereto. Adder 60 adds inphase component S_{I} from mixer 2002I and quadrature component S_{Q} from mixer 2002Q to generate a sum to be squared in multiplier 62. Multiplier 62 squares the sum to generate phase difference signal S_{PD} at two-times greater than the reference frequency. When inphase component S_{I} and quadrature component S_{Q} are 90 degrees out-of-phase with each other, phase difference signal S_{PD} approaches 0, thereby detecting phase difference between inphase and quadrature components S_{I} and S_{Q}.

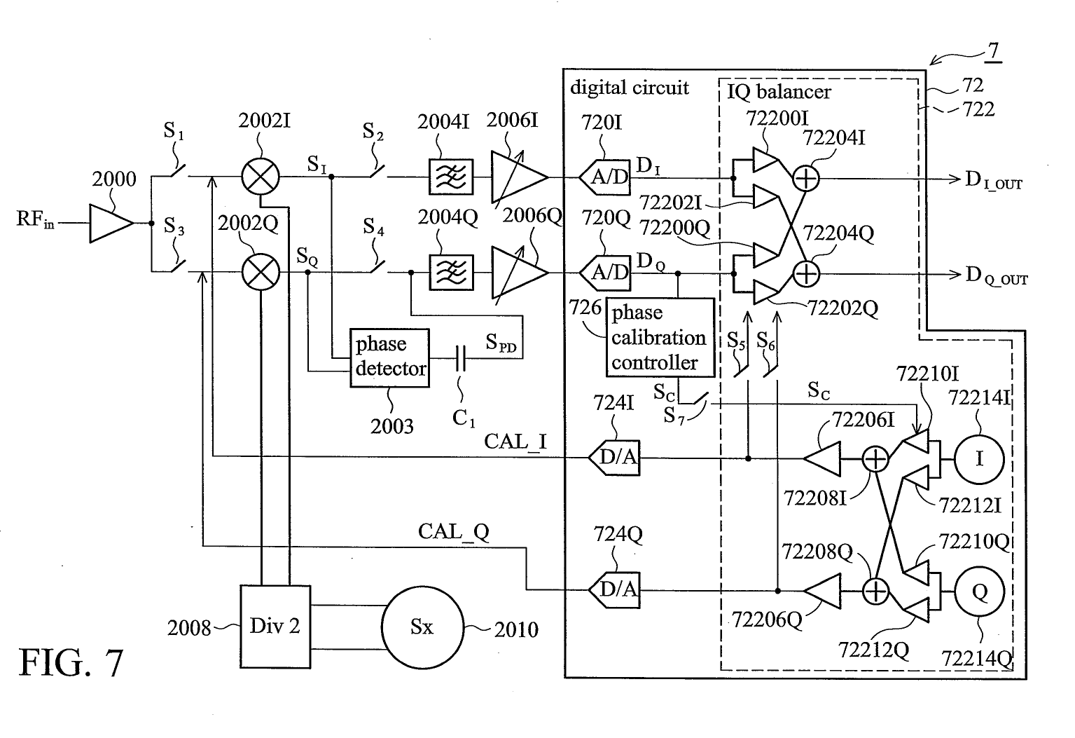

FIG. 7 is a block diagram of an exemplary direct conversion receiver according to the invention, comprising the analog circuit in FIG. 2 and digital circuit 72 coupled thereto.

During calibration, frequency generators 72214I, Q generate calibration signals S_{CAL}_{_{—}}I and S_{CAL}_{_{—}}_{Q} at a low reference frequency, for example, 100 kHz, with 0 degree phase shift at variable gain amplifiers 72212I, Q and 72210I, Q to determine and store I/Q phase mismatch by phase calibration controller 726.

During normal operation, incoming RF signal RFᵢₙ is down converted to baseband (zero frequency) in one step by mixing the local oscillation signal with the carrier frequency. Resulting baseband signals S_{I} and S_{Q} are then filtered with low pass filter 2004I, Q to select a desired channel which is amplified by PGA 2006I, Q to control the gain. After digital conversion, phase calibration controller 726 controls variable gain amplifiers 72200I, Q and 72204I, Q and shifts digital signals D_{I} and D_{S} by the amount of the I/Q phase mismatch, producing I/Q compensated output signals D_{I}_{_{—}}_{OUT} and D_{Q}_{_{—}}_{OUT}.

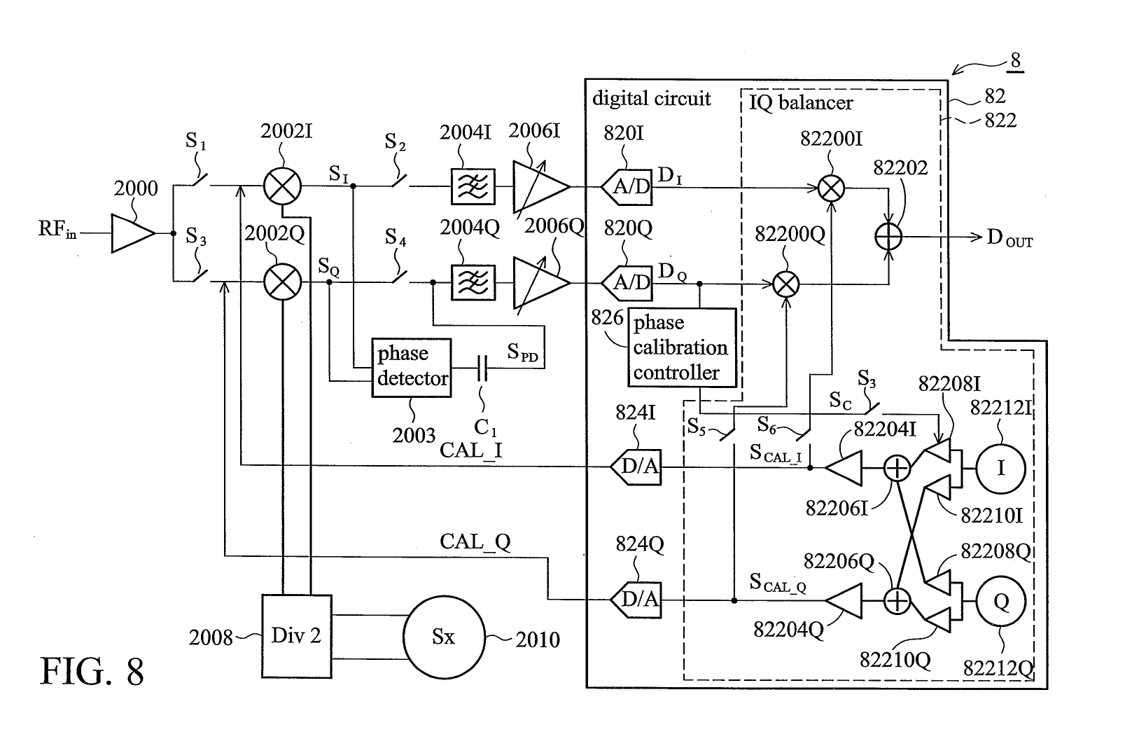

FIG. 8 is a block diagram of an exemplary weaver image reject receiver according to the invention, comprising the analog circuit in FIG. 2 and digital circuit 82 coupled thereto.

Incoming RF signal RFᵢₙ is mixed with the local oscillation signal. After filtering both mixer outputs by LPF 2004I, Q, filtered signals S_{I} and S_{Q} are converted to digital, one of the digital signals D_{I} and D_{S} is shifted by 90 degrees by mixers 82200I, Q. The sum of the two output signals from mixers 82200I, Q cancels the image band to yield output signal D_{OUT}. Consequently, weaver image reject receiver is sensitive to I/Q phase mismatch of the local oscillation signals which causes incomplete image cancellation.

Weaver image reject receiver 8 also utilizes mixers 82200I, Q to perform I/Q balance on digital signals D_{I} and D_{S}. During calibration mode, frequency generators 82212I, Q generate calibration signals S_{CAL}_{_{—}}_{I} and S_{CAL}_{_{—}}_{Q} at a low reference frequency, for example, 100 kHz, with 0 degree phase shift at variable gain amplifiers 82208I, Q and 82210I, Q to determine and store I/Q phase mismatch by phase calibration controller 826. During normal operation, Incoming RF signal RFᵢₙ is mixed with the local oscillation signal to produce digital signals D_{I} and D_{S}. At which point, phase calibration controller 826 controls variable gain amplifiers 82208I and 82210I to have a (90+θ) degree phase shift, and controls variable gain amplifiers 82208Q and 82210Q to have a q degree phase shift, with q selected as the I/Q phase mismatch. The sum of shifted digital signals D_{I} and DS thus results in an I/Q phase balanced, complete image cancelled output signal D_{OUT}.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of estimating I/Q (inphase/quadrature) phase mismatch in a receiver that comprises a mixer capable of mixing an incoming RF (Radio Frequency) signal with a local oscillation signal, comprising:
the mixer mixing an inphase calibration signal with an inphase component of the local oscillation signal to generate a first signal;
the mixer mixing a quadrature calibration signal with a quadrature component of the local oscillation signal to generate a second signal;
determining a phase difference between the first and second signals; and
adjusting phases of the inphase and quadrature calibration signals such that the phase difference is substantially 90 degrees.

2. The method of claim 1, wherein the inphase and quadrature calibration signals have an identical reference frequency, and determination comprises providing a squaring circuit to square a sum of the first and second signals to generate a third signal two-times greater than the reference frequency, and the adjustment comprises adjusting the phases of the inphase and quadrature calibration signals such that a magnitude of the third signal is reduced.

3. The method of claim 2, further comprises:
providing a DC block capacitor to remove a DC component of the third signal; and
providing a low pass filter to filter out an unwanted frequency component of the third signal that exceeds two-times the reference frequency.

4. The method of claim 1, further comprises:
the mixer mixing the incoming RF signal with the local oscillation signal to generate demodulated inphase and quadrature signals; and
compensating the demodulated inphase and quadrature signals with the adjusted phase to produce output inphase and quadrature signals.

5. The method of claim 4, wherein the compensation comprises adjusting phases of the demodulated inphase and quadrature signals by the adjusted phase.

6. The method of claim 1, wherein the inphase and quadrature calibration signals are analog, and the method further comprises: providing a digital-to-analog converter to convert digital inphase and quadrature calibration signals to analog.

7. The method of claim 1, wherein the first and second signals have baseband or intermediate frequency.

8. An integrated circuit capable of compensating I/Q (inphase/quadrature) phase mismatch, comprising:
a mixer mixing an inphase calibration signal with an inphase component of a local oscillation signal to generate a first signal, mixing a quadrature calibration signal with a quadrature component of the local oscillation signal to generate a second signal, and mixing an incoming RF signal with the local oscillation signal to demodulate the incoming RF signal;
a phase detector coupled to the mixer, determining a phase difference between the first and second signals; and
a calibration controller coupled to the phase detector, adjusting phases of the inphase and quadrature calibration signals such that the phase difference is substantially 90 degrees.

9. The integrated circuit of claim 8, wherein the inphase and quadrature calibration signals have an identical reference frequency, and phase detector is a squaring circuit squaring a sum of the first and second signals to generate a third signal two-times greater than the reference frequency, and calibration controller adjusts the phases of the inphase and quadrature calibration signals such that a magnitude of the third signal is reduced.

10. The integrated circuit of claim 9, further comprises:
a first capacitor in series with the mixer, removing a DC component of the third signal; and
a low pass filter in series with the first capacitor, filtering out an unwanted frequency component of the third signal that exceeds two-times the reference frequency.

11. The integrated circuit of claim 8, wherein the mixer mixes the incoming RF signal with the local oscillation signal to generate demodulated inphase and quadrature signals, and the integrated circuit further comprises an IQ balancer coupled to the phase detector, compensates the demodulated inphase and quadrature signals with the adjusted phase to produce output inphase and quadrature signals.

12. The integrated circuit of claim 11, wherein the IQ balancer adjusts phases of the demodulated inphase and quadrature signals by the adjusted phase.

13. The integrated circuit of claim 8, wherein the inphase and quadrature calibration signals are analog, and the integrated circuit further comprising a digital-to-analog converter (DAC) coupled to the mixer, converting digital inphase and quadrature calibration signals to analog.

14. The integrated circuit of claim 8, wherein the first and second signals have baseband or intermediate frequency.

15. An apparatus capable of compensating I/Q phase mismatch of a local oscillation signal, comprising:
a mixer mixing an inphase calibration signal with an inphase component of the local oscillation signal to generate a first signal, mixing a quadrature calibration signal with a quadrature component of the local oscillation signal to generate a second signal, and mixing an incoming RF signal with the local oscillation signal to demodulate the incoming RF signal;
a phase detector coupled to the mixer, determining a phase difference between the first and second signals; and
a calibration controller coupled to the phase detector, adjusting phases of the inphase and quadrature calibration signals such that the phase difference is substantially 90 degrees.

16. The apparatus of claim 15, wherein the inphase and quadrature calibration signals have an identical reference frequency, and the phase detector is a squaring circuit squaring a sum of the first and second signals to generate a third signal two-times greater than the reference frequency, and the calibration controller adjusts the phases of the inphase and quadrature calibration signals such that a magnitude of the third signal is reduced.

17. The apparatus of claim 16, further comprises:
a first capacitor in series with the mixer, removing a DC component of the third signal; and
a low pass filter in series with the first capacitor, filtering out an unwanted frequency component of the third signal that exceeds the twice reference frequency.

18. The integrated circuit of claim 15, wherein the mixer mixes the incoming RF signal with the local oscillation signal to generate demodulated inphase and quadrature signals, and the integrated circuit further comprises an IQ balancer coupled to the phase detector, compensating the demodulated inphase and quadrature signals with the adjusted phase to produce output inphase and quadrature signals.
